(19) United States
(12) Patent Application Publication
(10) Pub. No.: US 2025/0183347 A1
(43) Pub. Date: Jun. 5, 2025

(54) STACKING UNIT FOR PRODUCING MODULES OR PRECURSORS OF MODULES

(71) Applicant: MB Automation GmbH & Co. KG, Roding (DE)

(72) Inventors: Sebastian Penzl, Neukirchen beim Heiligen Blut (DE); Konstantin Koch, Roding (DE)

(21) Appl. No.: 18/842,669

(22) PCT Filed: Mar. 14, 2023
(86) PCT No.: PCT/EP2023/056416

§ 371 Date: Aug. 29, 2024

(30) Foreign Application Priority Data
Apr. 4, 2022 (DE) 10 2022 107 942.2

(51) Int. Cl. H01M 10/04

(52) U.S. Cl. CPC H01M 10/0404

(57) ABSTRACT

A stacking unit is used to produce modules or precursors of modules, in particular fuel or battery cells containing layer material, wherein at at least one stacking point a first lifting device with a holder can remove the at least one empty work piece carrier from a central transport section and, after filling, return it to the central transport section for conveying to a subsequent process station; one or more stacking devices can alternately transport individual anode layers and individual cathode layers to the stacking point to form an electrode stack and can stack them on the workpiece carrier located at the stacking point; and at least one first and at least one second clamping finger are provided and are set up to engage with the uppermost of the anode and cathode layers and to press them against the electrode stack.

### CROSS-REFERENCE TO RELATED APPLICATIONS

This application is a National Stage application of International Application No. PCT/EP2023/056416 filed Mar. 14, 2023, which claims priority to German Patent Application Serial No. DE 102022107942.2 filed Apr. 4, 2022.

### BACKGROUND

### Field

Disclosed herein are a stacking unit and a method for manufacturing modules or precursors of modules. These modules or precursors of modules can be fuel cells or battery cells containing layer material. Details are defined in the claims. The description also contains relevant information on the structure and mode of operation as well as on variants of the device and the method.

### Discussion of the Related Art

JP 2014 078464 A relates to a laminating machine for producing a laminated body of a rectangular film as a positive electrode, a rectangular film as a negative electrode, which are alternately laminated via a rectangular separating film. A conveyor is used to sequentially pick up and convey the cathode foil, the anode foil and the separating foil to a predetermined stacking position and to align and stack the cathode foil, the anode foil and the separating foil at the stacking position. Four first holding members are arranged at the four corners of the laminated body to be stacked at the stacking position and serve to press the four corners of the cathode foil transported from the conveyor to the stacking position and placed there, or the four corners of the release foil transported from the conveyor to the stacking position and placed there, from above to stack them under the cathode foil. First horizontal shifting means can shift the position of the first holding elements in the horizontal direction from a retracted position at least outside the cathode foil or the release foil to a holding position corresponding to the four corners of the cathode foil or the release foil. A first means for shifting in the vertical direction serves to shift the position of the first holding element in the vertical direction from a released position separated at least upwardly from the cathode foil or the separating foil to a contact position capable of contacting the cathode foil or the separating foil. Four second holding members are provided at the four corners of the laminated body to be stacked at the stacking position to press from above the four corners of the negative electrode film located at the stacking position or the four corners of the release film located at the stacking position to be stacked under the negative electrode film. Second horizontal shifting devices are used to shift the position of the second holding elements in the horizontal direction from a retracted position at least outside the anode foil or the separating foil to a holding position corresponding to the four corners of the anode foil or the separating foil. The second displacement devices for displacement in the vertical direction serve to displace the position of the second holding element in the vertical direction from a position separated at least upwards from the anode foil or the separating foil to a contact position in which the second holding element touches the anode foil or the separating foil. When a new cathode foil, anode foil or separating foil is conveyed and brought into the stacking position, the newly placed cathode foil, anode foil or separating foil is held down by and the four corners of the cathode foil, anode foil or separating foil already placed underneath are held down. After the four first or second holding elements have been pulled out, the four corners of the newly placed cathode foil, anode foil or separating foil are held down by the corresponding four first or second holding elements. The four corners of the newly placed cathode foil, anode foil or separator are pressed by four corresponding first or second holding elements. The height of the first and second holding elements when they move from the holding position to the holding position is set to be higher than the height of the first and second holding elements when they return from the holding position to the retracted position. When holding down the cathode foil, the anode foil or the separating foil when moving from the holding position to the retraction position, the stroke paths of the holding elements are higher than the stroke paths when moving from the holding position to the retraction position.

WO 2021 171 946 A1 relates to a testing device for testing the position of the electrode layer in a laminate, in which a release film and an electrode layer are bonded by an adhesive, from the release film side. An infrared irradiation unit irradiates the laminate with infrared light from the release film side. A camera sensitive to infrared light records the infrared light transmitted through the release film and reflected by the electrode layer. A detection unit detects the position of the electrode layer based on the image captured by the camera.

WO 2021 171 946 A1 also relates to a stacking table on which laminate stacks of release films and electrode layer are stacked. A transport unit is used to transport the release films and electrode layer and to place them on the stacking table. The test device above checks the position of the electrode layer in the laminate stack released by the transport unit.

DE 10 2017 216 152 A1 relates to a stacking device for multi-layer, flat stacks of electrodes. The stacking device can be moved in the Y-direction and optionally in the X-direction and comprises an exchangeable carrier. The exchangeable carrier is detachably mounted on guide elements, is designed to be exchangeable and comprises a support surface, which is acted upon by first biasing springs, which continuously adjust the electrode stacks stacked on the support surface against counter holders during handling of the exchangeable carrier. The method comprises at least the following steps.

DE 10 2017 216 184 A1 relates to a method for producing an electrode stack for a battery cell. Firstly, a belt-shaped separator element is provided. The separator element is moved by a transport device in a transport direction, while electrode segments are deposited on the separator element by a conveyor unit in a transport direction. The conveyor unit comprises a correction device with position sensors that detect the angle and position of the electrode segments before they are deposited.

DE 10 2018 221 571 A1 relates to a method and a device for producing an electrode stack of anodes and cathodes for a lithium-ion battery. The anode and cathode are each provided in a magazine, are conveyed without a gripper and stacked alternately in a chamber.

The transfer of the respective intermediate product from one machine to the next leads to deviations in production precision and delays. Overall, this results in large fluctuations in product quality.

Further devices and methods for producing layer stacks for fuel or battery cells are disclosed in documents EP 3 679 622 A1, JP 2019 021 607 A and JP 2020 024 816 A.

Based on this situation, a cost-effective and robust arrangement of a stacking unit and a procedure for stacking layer material with high processing speed is to be provided in order to manufacture modules or precursors of modules, for example fuel or battery cells containing layer material, with high precision.

### SUMMARY

To solve this problem, a device and a method according to the independent claims are proposed.

Such a stacking unit is used to produce modules or precursors of modules, including fuel or battery cells, which contain a layer material. At at least one stacking point, a first lifting device with a receptacle is provided and set up to use the receptacle to remove the at least one empty work piece carrier from a central transport section and, after filling, to return it to the central transport section for conveying to a downstream process station. One or more stacking devices are provided and set up to alternately transport individual anode layers and individual cathode layers to the stacking point to form an electrode stack and to stack them on the workpiece carrier located at the stacking point. At least one first and at least one second clamping finger are provided and arranged to engage with the uppermost of the anode and cathode layers and to press them against the electrode stack.

The device variants of the stacking unit and process variants for stacking layer material presented here allow very high precision, as the individual layers are continuously pressed together to form an (electrode) stack both during production and during transport. Both during stacking of the individual anode and cathode layers and during transport to the next process station, the individual layers are constantly pressed against the base of a storage space for the electrode stack on the workpiece carrier. The stacking of the individual layers on the workpiece carrier, which is always secured by the clamping fingers, and the secure clamping of the modules or their preliminary stages on the workpiece carriers during transport to the next process station can lead to more precise production of the modules compared to the state of the art and allow a comparatively higher output of modules per unit of time.

Further advantageous embodiments of the devices and methods are shown in the dependent claims.

In one variant, the stacking unit has a second lifting device and at least one positioning device, which are provided and set up to raise or lower the at least first and at least second clamping fingers relative to the workpiece carrier in the z-direction and/or to move them transversely to the electrode stack in order to come into or out of engagement with the uppermost of the anode and cathode layers and/or to press the uppermost of the anode and cathode layers against the electrode stack. In one variant, the stacking unit has at least one actuator which is provided and set up to open or close at least one clamp on the workpiece carrier. In one variant, the actuator is set up to bring the clamp into an open position during stacking of the anode and cathode layers. In one variant, the clamp is set up to hold the stack of electrodes on the workpiece carrier without actuation by the actuator while the workpiece carrier is being conveyed to a subsequent process station. In one variant, the stacking unit has several stacking points. In one variant, the second lifting device is provided and is set up to move the at least first and at least second clamping fingers and the at least one positioning device at all of the multiple stacking points (vertically) in the z-direction.

In one variant, one or two stacking devices are provided at each stacking point and are set up to alternately transport the individual anode layers and the individual cathode layers from two opposite sides of the central transport section to a stacking position above the workpiece carrier and to stack them on the workpiece carrier. In the case of two stacking devices at each stacking position, an increased throughput is achieved compared to a design with one stacking device at each stacking position.

In one variant, the stacking devices are provided and set up to pick up the individual anode layers and the individual cathode layers by means of controlled pneumatic negative pressure and to hold them above the workpiece during transport to the stacking position. Additionally or alternatively, the stacking devices are provided and set up to release the individual anode layers and the individual cathode layers in the stacking position by means of a controlled pneumatic overpressure in order to stack the layers on the workpiece carrier.

In one variant of the stacking unit, the first lifting device, for example a servomotor or linear drive, is provided and set up to lower the workpiece carrier during stacking of the individual anode layers and individual cathode layers by a distance that essentially corresponds to the thickness of an individual anode layer or an individual cathode layer. This allows the individual anode layers and cathode layers to be brought in and out quickly without having to carry out time-consuming positioning processes of the stacking devices.

In one variant of the stacking unit, in the case of two stacking devices assigned to a stacking point, a first of the stacking devices is provided and set up to transport only individual anode layers to the stacking point, and a second of the stacking devices is provided and set up to transport only individual cathode layers to the stacking point.

In one variant of the stacking unit, each of the stacking devices has an attachment for the individual layers. In one variant, the system has at least one underpressure/overpressure opening or a porous underpressure/overpressure area at which the individual layers are held during transport to the stacking position. In one variant, the system has recesses which are provided and dimensioned for receiving the at least two clamping fingers before the individual layers are stacked on the work- piece carrier, and for releasing the at least two clamping fingers in the direction of the electrode stack in order to press the uppermost of the anode and cathode layers against the electrode stack.

In a variant of the stacking unit, each of the stacking devices is provided and set up to be brought into the stacking position in a controlled manner at a distance above the electrode stack which corresponds to the thickness of fewer of the individual anode layers or the individual cathode layers, for example about 0.2-5 layers, in order to release the individual anode layers and the individual cathode layers from there by switching off a pneumatic negative pressure and/or building up a pneumatic positive pressure and/or lowering at least one of the at least two clamping fingers in order to always press the layers against the electrode stack on the workpiece carrier.

In one variant of the stacking unit, the at least two clamping fingers are provided and arranged to alternately press and clamp the individual layers onto the workpiece carrier. In one variant of the stacking unit, the clamping fingers are assigned to a group of first clamping fingers and a group of second clamping fingers, and are provided and arranged to press the uppermost of the anode and cathode layers against the electrode stack in groups from one or two sides of the anode and cathode layers. In one variant of the stacking unit, each of the group of first clamping fingers and the group of second clamping fingers is divided into at least two clamping fingers on two opposite sides of each stacking point. In one variant of the stacking unit, clamping fingers of a group located on the same side of the stacking point have a common drive.

In one variant of the stacking unit, each of the stacking devices is provided and set up to reach the stacking position at a distance (a) above the stack of electrodes on the workpiece carrier in a controlled manner, the distance (a) corresponding to the thickness of one or more individual anode layers or cathode layers, for example about 0.2-5 layers, in order to stack the individual anode and cathode layers on the workpiece carrier from there by lowering at least one of the clamping fingers.

In one variant of the stacking unit, a receptacle is provided at each stacking point and is set up to receive at least one empty workpiece carrier and to pick it up in at least one direction with positional accuracy. In one variant of the stacking unit, each workpiece carrier has an upper side on which one or more clamps are arranged and are set up to clamp electrode stacks located on the upper side of the work- piece carrier during transport to the next process station. In one variant of the stacking unit, each clamp has at least one clamping jaw which is designed to bear on the stack of electrodes in a first position and to release a storage space for the stack of electrodes on the workpiece carrier in a second position. In a variant of the stacking unit, each clamp has a spring device which is set up to urge the clamping jaw into the first position on the electrode stack and has a pressing point which is set up to receive a force introduction of the actuator in the stacking unit, the force introduced being directed against the spring device and causing the clamping jaw to release the storage space.

A process for the production of modules or precursors of modules, in particular of fuel or battery cells containing layer material, comprises—in any order, for example the following order—the steps:
At at least one stacking point, a pick-up receives at least one empty workpiece carrier from a central transport section.
A first lifting device uses the holder to remove the at least one empty work piece carrier from the central transport section and, after filling, returns it to the central transport section for conveying to a subsequent process station. One or more stacking devices transport individual anode layers and individual cathode layers alternately to the stacking point to form an electrode stack and stack the layers on the workpiece carrier located at the stacking point. At least one first and at least one second clamping finger come into contact with the uppermost of the anode and cathode layers and press them against the electrode stack.

In one variant, the central transport section of the stacking unit comprises a carriage that can be moved in and against the conveying direction of the workpiece carriers in a controlled manner. This carriage is designed to pick up one or more of the workpiece carriers, convey them into a pick-up area of the stacking unit, from the pick-up area into a stacking area and from the stacking area into a delivery area.

In one variant, the stacking unit comprises one or more first lifting devices which are set up to vertically remove one or more workpiece carriers from the central transport section and put them back by lifting this/these workpiece carrier(s) from the carriage in the z-direction in a controlled manner or setting them down in the z-direction.

In one variant, the stacking unit comprises a first transport section with a pick-up area, a stacking area and a delivery area; several first lifting devices in the stacking area; a carriage which can be positioned in and against a forward path along a first transport section and is set up to position several empty workpiece carriers in groups from the pick-up area into the stacking area and/or several workpiece carriers, each of which carries a stack created in the stacking area, from the stacking area into the delivery area.

In one variant of the stacking unit, the lifting devices are set up to lift the respective workpiece carrier from the slide for stacking individual anode and individual cathode layers on the electrode stack located on the workpiece carrier.

In one variant of the stacking unit, the slide has a length in the conveying direction of the workpiece carriers that at least approximately corresponds to the extension of the pick-up area and the stacking area or the stacking area and the delivery area in the conveying direction of the workpiece carriers.

In one variant of the stacking unit, the carriage is arranged to move longitudinally on two opposing linear guides and has 2×N holders on each longitudinal side for N workpiece carriers to be positioned, whereby the lifting devices are set up to extend between the linear guides.

In one variant of the stacking unit, a lifting device is provided for the workpiece carriers in the pick-up area and a lifting device in the delivery area.

A method is used to manufacture modules or precursors of modules, in particular layer material and/or fuel or battery cells, whereby one or more work- piece carriers are removed from the central transport section in a first process station designed as a stacking unit. Individual anode layers and individual cathode layers are alternately stacked on at least one workpiece carrier taken from the central transport section at at least one stacking point of the stacking unit to form an electrode stack on the respective workpiece carrier. The one or more workpiece carriers with the stack of electrodes on them are then placed back on the central transport section.

Process aspects are shown above in device terms and vice versa. Both the process aspects and the device terms are used to explain the stacking unit and its operation.

### BRIEF DESCRIPTION OF THE DRAWINGS

Further features, properties and advantages of the devices and the methods can be found in the following description in conjunction with the drawing. Possible variations will become clear to a person skilled in the art from the following description, in which reference is made to the accompanying drawings. The figures show schematically the devices discussed here and explain their operation.

FIG. 1 a schematic top view of an assembly line for the production of modules or precursors of modules;

FIG. 2 schematic side view of a stacking unit designed as a process station of the assembly line of FIG. 1;

FIGS. 2a-2f schematic side views of successive settings of the stacking unit of FIG. 2 in respective process steps;

FIG. 3 a schematic view from below of a flat stacking device for the individual layers with different positions for clamping fingers; and

FIGS. 3a-3b the flat arrangement of the stacking device from FIG. 3 with respective configurations of clamping fingers.

### DETAILED DESCRIPTION OF THE EMBODIMENTS

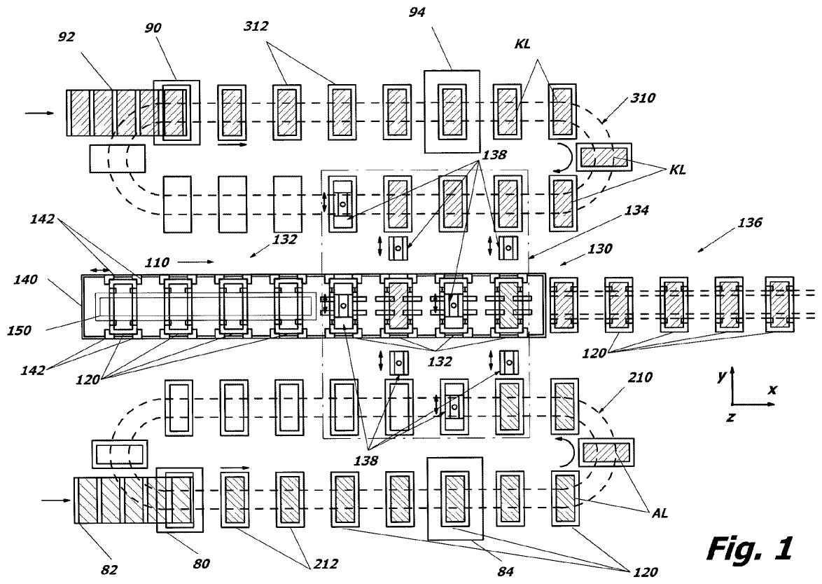

FIG. 1 schematically illustrates a part of an assembly line 100 for the manufacture of modules or precursors of modules. Here, the assembly line 100 is explained by way of example using the manufacture of fuel or battery cells containing layer material and/or fluid. A central transport section 110 conveys a large number of workpiece carriers 120 between several process stations. The central transport section 110 is set up by means of drives, not shown further, to convey the workpiece carriers 120 in groups in individual transport sections.

As supply stations to the assembly line 100, a first cutting or punching station, not shown further, is set up to cut a first endless layer material coming from a roll into uniform rectangular pieces and to deliver it onto a carrier 82 as a sequence of isolated anode layers AL. A second cutting or punching station, not shown further, is set up to cut a second continuous layer material 92 coming from a roll into uniform rectangular pieces and to deliver it onto a carrier 92 as a sequence of separated cathode layers KL. A first depositing station 80 feeds the separated anode layers AL onto a first transport section 210. A second depositing station 90 feeds the separated cathode layers KL onto a second transport section 310 in order to feed them to a stacking unit 130. On their transport to the stacking unit 130, the anode and cathode layers AL, KL are guided through an inspection station 84, 94 assigned to the respective transport section 210, 310 in order to check their quality and/or alignment. In one variant, the cathode is a metal foil with a conductive coating on both sides and a protruding arrester tab. In one variant, the anode is a metal foil with a conductive coating on both sides, which is laminated between two dielectric foils (separators), wherein the current conductor tab protrudes laterally, i.e. on one of the short sides between the separators.

Such an assembly line 100 has a first transport section 116 with the pick-up area 132, the stacking area 134 and the delivery area 136. A plurality of first lifting devices 135 are provided in the stacking area 134 in order to lift workpiece carriers 120 from the carriage 140 in the z-direction. The carriage 140 can be positioned in and against the outward path 112 along a first transport section 116. The carriage 140 is arranged to position a plurality of empty workpiece carriers 120 in groups from the pick-up area 132 into the stacking area 134 and/or a plurality of work-piece carriers, each carrying a stack created in the stacking area 134, from the stacking area 134 into the delivery area 136. Each lifting device 135 is arranged to lift the respective workpiece carrier 120 for stacking from the carriage 140. In the conveying direction (x-direction) of the workpiece carriers 120, the carriage 140 has a length which corresponds at least approximately to the extension of the receiving area 132 and the stacking area 134, or of the stacking area 134 and the delivery area 136 in the conveying direction of the workpiece carriers 120. The carriage 140 is arranged to move longitudinally on two opposing linear guides and has 2×N holders 142 on each longitudinal side for N workpiece carriers 120 to be positioned. The lifting devices 135 extend between the linear guides for this purpose and can thus lift the N workpiece carriers 120 remaining at their respective x, y position in the z direction, while the carriage 140 is moved along the linear guides (in the x-direction). Similarly, the lifting device 150 is provided in the pick-up area 132 for the N workpiece carriers 120 and a lifting device is provided in the delivery area 136 in each case.

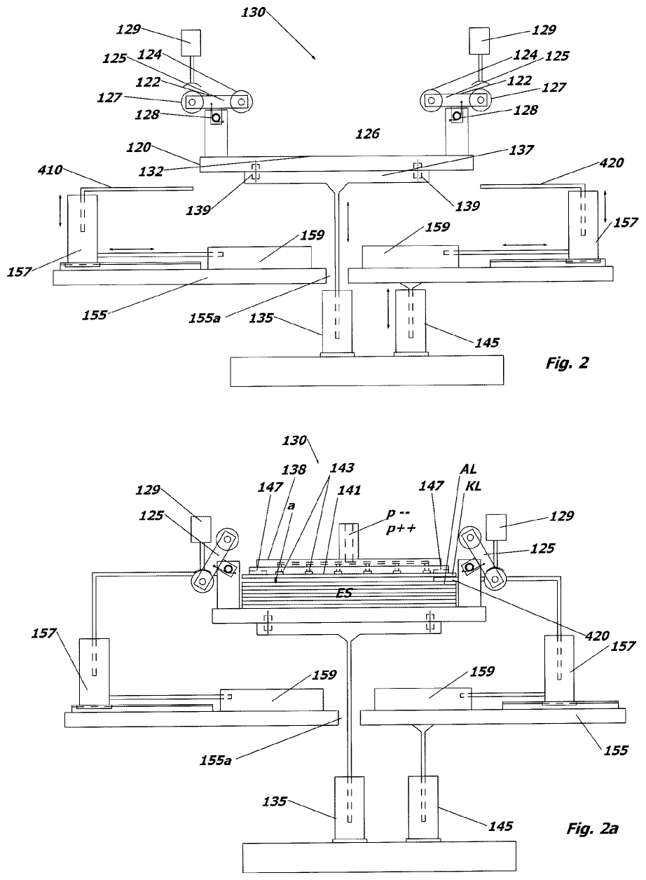

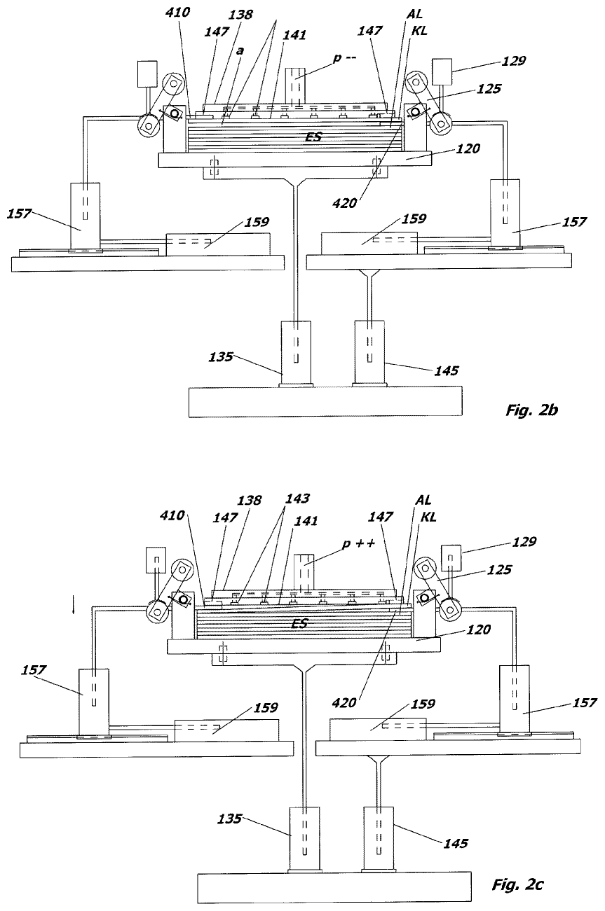

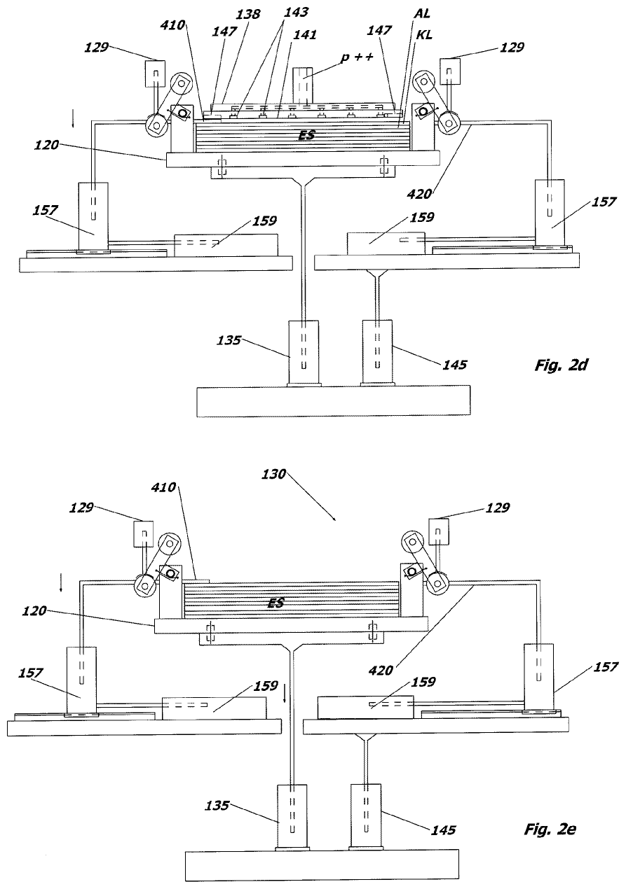

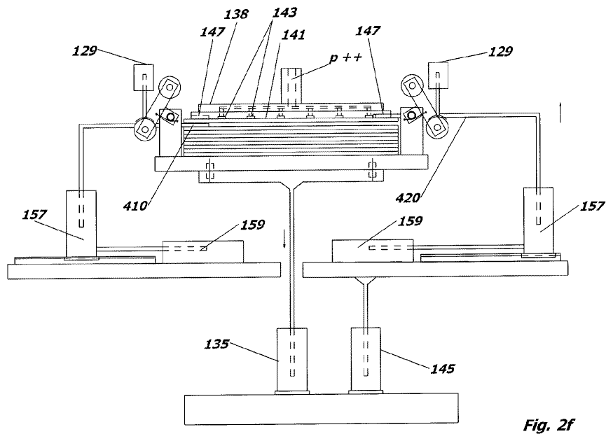

In the receiving area 132, several workpiece carriers 120—here as a group of four—can be removed from the central transport section 110 in the variant shown here. In other variants, more or fewer than four workpiece carriers 120 can also be removed from the central transport section 110. For this purpose, the central transport section 110 has a lifting device 150 on the upstream side of the stacking unit 130 in the receiving area 132, which in one variant can be part of the central transport section 110, here in the form of a scissor lift table. The lifting device 150 is designed to lift a group of four workpiece carriers 120 from the central transport section 110 in the receiving area 132 and place them on a carriage 140. In one variant, the carriage 140 can also be part of the central transport section 110. This carriage 140 in the stacking unit 130 is to be moved in and against the conveying direction x of the work-piece carriers 120 in a controlled manner by means of a drive, which is not illustrated further, in order to pick up the group of workpiece carriers 120, to convey it into the receiving area 132 of the stacking unit 130, from the receiving area 132 into a stacking area 134, and from the stacking area 134 into a delivery area 136. Details of this movement sequence are explained below with reference to FIGS. 2a-2f.

In the stacking area 134, individual anode layers AL and individual cathode layers KL are transported into the stacking area 134 with a number of stacking devices 138 (here four) corresponding to the number of workpiece carriers 120 in the group from a respective first and second transport section 210, 310 located on both longitudinal sides of the central transport section 120 with vacuum or adhesive trays 212, 312, also referred to as shuttles (see also FIG. 1). In other words, two stacking devices 138 are assigned to each workpiece carrier 120 in the stacking area 134. For this purpose, the arrangement of the stacking devices 138 is equipped with respective drives, not further illustrated, in order to move the stacking devices 138 individually vertically in the z-direction for raising and lowering the individual anode and cathode layers KL.

Further drives, which are not illustrated, are used to move the stacking devices 138 individually horizontally in the y-direction, transverse to the central transport section 110, in order to transport the individual anode and cathode layers AL, KL from the trays of the first and second transport sections 210, 310 to the respective stacking point 133 on the workpiece carrier 120 in the stacking area 134. In the process, individual anode layers AL from a first side of the workpiece carrier 120 and individual cathode layers KL from a second side of the workpiece carrier 120 are alternately brought to the respective workpiece carrier 120 and stacked to form an electrode stack ES on the respective workpiece carrier 120 on the workpiece carrier 120 taken from the central transport section 110. The assembly line 100/the stacking unit 130 according to FIG. 1 comprises, by way of example, 4 stacking points 133. The stacking unit 130 furthermore has a plurality of first lifting devices 135 acting in the z-direction, one per workpiece carrier 120, in order to lift the workpiece carriers 120 from the carriage 140 in the z-direction in a controlled manner and thus separate them from the carriage 140, and to set these workpiece carrier(s) 120 down on the carriage 140 in the z-direction in a controlled manner. In this way, the workpiece carriers 120 can be loaded with the layer material for forming the electrode stacks ES, while the carriage 140 can be moved back and forth in the x-direction.

At each stacking point 133, a flat holder 137 with a positioning pin 139 is provided, which receives an empty workpiece carrier 120 and holds it here in a precise position (see FIG. 2). Each workpiece carrier 120 has an upper side on which one or more clamps 122 are arranged. For example, two clamps 122 on each of two opposite sides of the workpiece carrier 120. These clamps 122 clamp an electrode stack ES located on the upper side of the workpiece carrier 120 while it is being transported to the next process station. For this purpose, each clamp 122 has a swiveling roller as clamping jaw 124, which is set up to bear on the electrode stack ES in a first position (see FIG. 2), and in a second position, which is raised in this variant (see FIG. 2a), to release a storage space 126 for the electrode stack ES on the workpiece carrier 120. Each clamp 122 has a pretensioned coil spring as a spring device 128, which is set up to urge the clamping jaw 124 into the first position on the electrode stack ES. In addition, each clamp 122 has a pivotable roller as a pressing point 127, which is set up to receive a force introduction of the actuator in the stacking unit, the introduced force being directed against the spring device 128 and causing the clamping jaw 124 to release the deposit space 126.

In order to ensure that the individual anode layers AL and cathode layers KL are securely held together and do not slip relative to one another, a plurality of clamps 122 are arranged on the upper side of the workpiece carrier 120 and are designed to clamp electrode stacks ES located on the upper side of the workpiece carrier 120 during transport between the process stations. For this purpose, each clamp 122 has a roller-shaped clamping jaw 124 which is arranged on a rocker 125 in order to bear on the electrode stack ES in a first position (see FIG. 2) and, in a second position (see FIG. 2a), to release a storage space 126 for the electrode stack ES on the workpiece carrier 120 upwards for the stacking devices 138 or other processing tools. Each clamp 122 has a spring device 128, which is set up to urge the clamping jaw 124 into the first position on the electrode stack ES. In particular, each actuator 129 is configured here as a linear actuator, for example in the form of a pneumatic cylinder, and is configured to bring and hold one or more clamps 122 on the workpiece carrier 120 or on a plurality of neighboring workpiece carriers 120 in an open position during the stacking of the anode and cathode layers AL, KL, so that depositing of the anode and cathode layers AL, KL on the workpiece carrier 120 can take place unhindered. Subsequently, the actuator(s) 129 releases the clamp(s) 122 so that the clamp(s) 122 move into a closed position without actuator actuation and hold the electrode stack ES on the workpiece carrier 120 while the workpiece carrier 120 is conveyed to a subsequent process station.

In FIG. 2, a workpiece carrier 120 located in the stacking unit 130 on one of the first lifting devices 135 is shown, which is lifted out of the carriage 140 not shown and is located at a stacking point 133. At this stacking point 133, the empty workpiece carrier 120 is filled as described below and then returned to the central transport section 110 for conveying to a subsequent process station. As described above, the first lifting device 135 serves to remove the at least one empty work piece carrier 120 from the central transport section 110. At each stacking point 133, a stacking device 138 transports the individual anode layers AL (bottom in FIG. 1) and a stacking device 138 transports the individual cathode layers KL (top in FIG. 1) alternately from both sides of the workpiece carrier 120 in and against the y-direction and stacks them on the workpiece carrier 120 in the z-direction. In this way, the electrode stack ES grows to the desired number of layers.

As illustrated in FIG. 2, at least one first and at least one second clamping finger 410, 420 are provided on both sides of the workpiece carrier 120, which come into engagement with the respective uppermost of the anode and cathode layers AL, KL and always press these against the growing electrode stack ES. The clamping fingers 410, 420 are arranged along the longitudinal sides of the workpiece carrier 120 located on the holder 137 in the Y-direction adjacent to the clamps 122. A second lifting device 145, also acting in the z-direction, lifts a plate 155 in the z-direction, on which the positioning devices 157, 159 for the clamping fingers 410, 420 acting on both sides of the holder 137 are arranged. In particular, adjusting devices 157 acting vertically in the z-direction are arranged on the plate 155 for raising and lowering the clamping fingers 410, 420.

Furthermore, horizontally acting actuators 159 are arranged on the plate 155 in the x-direction for moving the clamping fingers 410, 420 into and out of the stacking path of the anode and cathode layers AL, KL. The vertically acting actuating device 157 is moved in the X direction together with the clamping finger 410, 420 by the horizontally acting actuating device 159. The clamping fingers 410, 420 are formed here from spring steel in order to bear resiliently on the anode and cathode layers AL, KL. The plate 155 has an opening 155a approximately in its center. A part of the first lifting device 135, e.g. a lifting spindle, passes through the opening of the plate 155. This structure according to FIG. 2 enables a particularly compact stacking unit 130. The second lifting device 145 enables the empty or filled workpiece carriers 120 to be conveyed towards and away by the carriage 140 into the stacking area 134 or out of the stacking area 134 without the clamping fingers colliding with the carriage 140.

The clamping fingers 410, 420 can be raised or lowered or moved transversely to the electrode stack ES using the adjusting devices 157, 159. In this way, the clamping fingers 410, 420 can come into or out of engagement with the uppermost of the anode and cathode layers AL, KL and press the uppermost of the anode and cathode layers AL, KL against the electrode stack ES.

Each of the stacking devices 138 is intended and set up to either pick up the individual anode layers AL/the individual cathode layers KL by means of controlled pneumatical negative pressure and to hold them above the workpiece carrier 120 during transport to the stacking position. In one variant, it is also intended to release the individual anode layers AL and the individual cathode layers KL in the stacking position by means of a short controlled pneumatic overpressure shock in order to stack the layers AL, KL on the workpiece carrier 120.

For this purpose, each of the stacking devices 138 has a flat support 141 for the individual layers AL, KL, which has a plurality of vacuum/overpressure openings 143. The individual layers AL, KL adhere to this by controlled pneumatic negative pressure during transport to the stacking position 133.

The planar system 141 also has recesses 147, in each of which there is space for one of the clamping fingers 410, 420. In a controlled manner, before the individual layers AL, KL are stacked on the workpiece carrier 120, one of the clamping fingers 410, 420 is inserted laterally into the corresponding recess 147 by its positioning device 159 acting horizontally in the x-direction. The respective clamping finger 410, 420 is then moved downwards in the z-direction in the direction of the electrode stack ES by its adjusting device 159, which acts vertically in the z-direction, in order to press the uppermost of the anode and cathode layers AL, KL—together with the short controlled pneumatic overpressure shock—against the electrode stack ES on the work-piece carrier 120.

Each of the stacking devices 138 has an actuator, not further illustrated, acting horizontally in the y-direction and an actuator, not further illustrated, acting vertically in the z-direction. Each of the stacking devices 138 is thus controlled to be brought into the stacking position at a distance a above the electrode stack ES which corresponds to the thickness of fewer of the individual layers AL, KL, for example about 0.2-5 layers, in the variant of a layer shown here. From there, the individual layers AL, KL are released from the respective stack device 138 by switching off the pneumatic negative pressure p−− and building up the pneumatic positive pressure p++, as well as by lowering at least one of the clamping fingers 410, 420, while the layers AL, KL are always pressed against the electrode stack ES on the workpiece carrier 120.

In FIGS. 2, 2a-2f, only one clamping finger 410, 420 is shown on each side of the workpiece carrier 120 for a better overview, in order to alternately press the individual layers AL, KL against the electrode stack ES on the workpiece carrier 120 and clamp them there.

In FIG. 2a, an already partially stacked electrode stack ES on the workpiece carrier 120 is illustrated, wherein a stacking device 138 has conveyed a cathode layer KL in order to bring it into the stacking position at the distance a above the electrode stack ES. From a previous process step, the clamping finger 420 (on the right in FIG. 2a) rests on the electrode stack ES, the uppermost layer of which is an anode layer AL at the present stage.

FIG. 2b illustrates how the clamping finger 410 (on the left in FIG. 2a) is inserted horizontally in the x-direction into the recess 147 of the system 141 above the cathode position KL, which is held on the system 141 by negative pressure p−−, by the adjusting device 159 on the left in FIG. 2b.

FIG. 2c illustrates how the clamping finger 410 (on the left in FIG. 2a) is moved vertically in the z-direction out of the recess 147 of the system 141 by the adjusting device 157 on the left in FIG. 2c and pushes the cathode layer KL in the direction of the electrode stack ES. At the same time, an overpressure push p++ occurs from the underpressure/overpressure openings 143 of the system 141. FIG. 2d illustrates how the clamping finger 420 (on the right in FIG. 2a) is pulled out horizontally in the x-direction from the recess 147 of the system 141 by the actuating device 159 on the right in FIG. 2d. The overpressure push p++ from the vacuum/overpressure openings 143 of the system 141 pushes the cathode layer KL over its entire surface in the direction of the electrode stack ES, while the clamping finger 410 (on the left in FIG. 2a) pushes the cathode layer KL in the direction of the electrode stack ES and holds it in position.

FIG. 2e illustrates how the workpiece carrier 120 with the electrode stack ES, which has grown by one layer, is moved vertically downwards in the z-direction by the thickness of one layer by the first lifting device 135. In this way, the work-piece carrier is lowered by the thickness of one layer each time a cathode layer KL or an anode layer AL is deposited.

This vertical movement by the thickness of a layer downwards in the z-direction, actuated by the left-hand positioning device 157 downwards, is also carried out simultaneously by the clamping finger 410 (on the left in FIG. 2a), which pushes the cathode layer KL in the direction of the electrode stack ES and holds it in position. Meanwhile, one stacking device 138, which has transported the cathode layer KL towards it, moves out of the stacking position, freeing up the space at the stacking position for the stacking device 138, which transports the next anode layer KL towards it.

FIG. 2f shows-with the sides reversed-the situation shown in FIG. 2b. Here, the clamping finger 420 (on the right in FIG. 2f) is inserted horizontally in the x-direction into the recess 147 of the support 141 of the newly brought stacking device 138 above the anode layer AL held on the support 141 by negative pressure p−−, by the adjusting device 159 on the right in FIG. 2f. During the entire time, the clamping finger 410 (on the left in FIG. 2a), actuated downwards by the left adjusting device 157, holds the uppermost cathode layer KL pressed onto the electrode stack ES and in position.

The sequence of steps shown in FIGS. 2b-2f—with reversed sides—is continued until the required height of the electrode stack ES is reached.

When the electrode stack ES has reached its required height of anode layers AL and cathode layers KL, the workpiece carrier 120 is set down on the pick-up 142 of the carriage 140, which is located in the appropriate x-position, by the first lifting device 135. The same happens for the remaining workpiece carriers 120 of the group by a respective first lifting device 135. The carriage 140 then transports the group of four workpiece carriers 120 with the respective electrode stacks ES located thereon from the stacking area 134 to the delivery area 136.

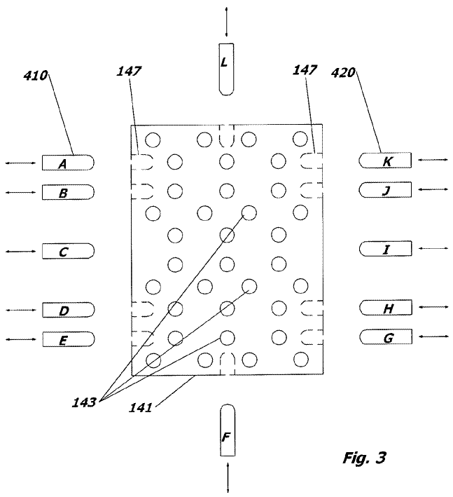

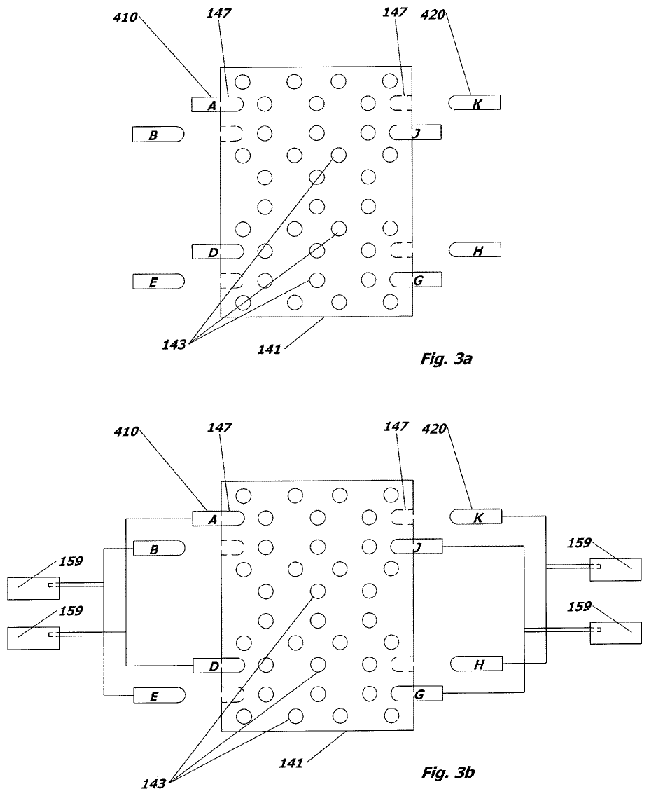

FIG. 3 illustrates the underside of the stacking device 138 with its recesses 147 for one of the clamping fingers 410, 420 in each case, which faces the workpiece carrier 120 on which the electrode stack ES is built up. In addition, a possible arrangement of the vacuum/overpressure openings 143 is shown, to which the individual layers AL, KL adhere firmly by controlled pneumatic vacuum p−− during transport to the stacking position.

In order that the clamping fingers 410, 420 as groups of first and second clamping fingers from several sides of the workpiece carrier 120 press the respective uppermost of the anode and cathode layers AL, KL against the electrode stack ES, several movement sequences are possible, some of which are explained below.

The recesses 147 shown in FIG. 3 and the positions A-L for the clamping fingers are not all present in specific embodiments. In the following variants, only some of the positions A-L are used for the clamping fingers.

In a first variant, only positions C and I are used for the clamping fingers, which alternately press the uppermost of the rectangular anode and cathode layers AL, KL against the electrode stack ES at their opposite long edges and fix them in position, as shown in FIGS. 2a-2f. In a variation of this, the positions F and L on the opposite short edges of the rectangular anode and cathode layers AL, KL are used for the clamping fingers. Alternatively, these can also be diagonally opposite positions for the clamping fingers, such as positions A and G, E and K, B and H, or D and J.

In a further variant, positions L and F alternate in groups with positions C and I, or positions D and F alternate with positions I and L in engagement with the uppermost layer in order to press it against the electrode stack ES and fix it in position.

In a further variant, positions A and G alternate in groups with positions E and K, or positions B and H alternate with positions D and J in engagement with the uppermost layer in order to press it against the electrode stack ES and fix it in position.

In a further variant, positions A and E alternate in groups with positions G and K, or positions B and D alternate with positions H and J in engagement with the uppermost layer in order to press it against the electrode stack ES and fix it in position.

In a further variant, the positions A, F and G are engaged in groups in a first step with the uppermost layer in order to urge these against the electrode stack ES and fix them in their position, and in a second step the positions L, K and E are engaged with the uppermost layer in order to urge these against the electrode stack ES and fix them in their position. Alternatively, in a first step, positions B, F and H are engaged in groups with the uppermost layer in order to press them against the electrode stack ES and fix them in their position, and in a second step, positions L, J and D are engaged with the uppermost layer in order to press them against the electrode stack ES and fix them in their position.

In a further variant, positions B, D, H and J are engaged in groups in a first step with the uppermost layer in order to press them against the electrode stack ES and fix them in position, and positions A, E, G and K are engaged in a second step with the uppermost layer in order to press them against the electrode stack ES and fix them in position. The clamping fingers of the opposing positions A, K and B, J and D, H and E, G can each be assigned to a common horizontal actuator 159 with a counter-rotating spindle.

In a further variant, the positions A, B, H and G are engaged in groups in a first step with the uppermost layer in order to press it against the electrode stack ES and fix it in position, and in a second step the positions D, E, J and K are engaged with the uppermost layer in order to press it against the electrode stack ES and fix it in position. Here, the clamping fingers of the neighboring positions A, B and H, G and D, E and J, K can each be assigned to a common horizontal actuator 159. It should be understood that the individual clamping fingers of the individual positions can also each be assigned to their own horizontal actuator 159.

In a further variant, the positions A, D, G and J are engaged in groups in a first step with the uppermost layer in order to press it against the electrode stack ES and fix it in position, and in a second step the positions B, E, H and K are engaged with the uppermost layer in order to press it against the electrode stack ES and fix it in position. This variant is illustrated schematically in FIG. 3a. This variant optimizes the advantages of clamping near the corners of the layers. The further away from a corner the clamping finger rests on the layer, the more likely it is that the stack will slip in the outer area or that the layers will wrinkle. In this case, each clamping finger has its own horizontal actuator 159. This variant from FIG. 3a can be modified in such a way that the clamping fingers that engage and disengage together on the same longitudinal side A and D, B and E, K and H, J and G are each assigned to a common horizontal actuator 159, see FIG. 3b. In other words, on one or on each of the two longitudinal sides, two not directly neighboring clamping fingers, for example A and D, have a common actuator 159. Consequently, there is a first carrier plate connected to the plate 155 and displaceable in the X-direction, on which the two adjusting devices 157 acting vertically in the z-direction for the fingers A and D are arranged. A common actuator 159 positions the first carrier plate. The two actuators 157 for fingers B and E are arranged on a second carrier plate. These two carrier plates partially interlock during positioning in the x-direction. This applies analogously to the clamping fingers K-H and J-G.

The variants of the stacking unit described above, their structural and operational aspects, as well as the variants of the method are merely intended to provide a better understanding of the structure, the mode of operation and the properties; they do not limit the disclosure to the embodiments. The figures are partly schematic. Essential properties and effects are shown, in some cases clearly enlarged, in order to clarify the functions, operating principles, technical embodiments and features. Each mode of operation, each principle, each technical embodiment and each feature disclosed in the Fig. or in the text can be freely and arbitrarily combined with all claims, each feature in the text and in the other Fig., other modes of operation, principles, technical embodiments and features contained in this disclosure or resulting therefrom, so that all conceivable combinations can be assigned to the procedure described. This also includes combinations between all individual embodiments in the text, i.e. in each section of the description, in the claims and also combinations between different variants in the text, in the claims and in the figures. Nor do the claims limit the disclosure and thus the possible combinations of all the features disclosed. All disclosed features are also explicitly disclosed here individually and in combination with all other features.

1. A stacking unit for the production of modules or precursors of modules comprising:
a first lifting device including a receptacle provided at at least one stacking location and is configured to use the receptacle to remove at least one empty work piece carrier from a central transport section and, after filling, to return the work piece carrier to the central transport section for conveying to a subsequent process station;
one or more stacking devices arranged to alternately transport individual anode layers and individual cathode layers to the stacking location to form an electrode stack and to stack the anode layers and the cathode layers on the workpiece carrier located at the stacking location; and
wherein the stacking unit is characterized in that
at least one first and at least one second clamping finger are provided and are arranged to engage alternately with an uppermost of the anode and cathode layers and to press and clamp the anode and cathode layers against the electrode stack and onto the workpiece carrier.

2. The stacking unit according to claim 1, wherein
a second lifting device and at least one positioning device are provided and arranged to raise or lower the at least first and at least second clamping fingers and/or to move the at least first and at least second clamping fingers transversely to the electrode stack in order to come into or out of engagement with the respective uppermost of the anode and cathode layers and/or to press the respective uppermost of the anode and cathode layers against the electrode stack; and/or
at least one actuator is provided and arranged to open or close at least one clamp on the workpiece carrier, the actuator being arranged to bring the clamp into an open position during stacking of the anode and cathode layers into an open position, and the clamp is configured to hold the stack of electrodes on the workpiece carrier without actuation by the actuator during the conveying of the workpiece carrier to a subsequent process station; and
the second lifting device is provided and configured to move the at least first and at least second clamping fingers and the at least one positioning device in the z-direction; and
one or two stacking devices are provided at each stacking location and are configured to transport the individual anode layers and the individual cathode layers from two opposite sides of the central transport section alternately to a stacking position above the workpiece carrier and to stack the anode layers and the cathode layers on the workpiece carrier; and/or
the stacking devices are provided and configured to pick up the individual anode layers and the individual cathode layers by a controlled pneumatic negative pressure and hold the anode layers and the cathode layers above the workpiece carrier during transport to the stacking position; and/or to release the individual anode layers and the individual cathode layers in the stacking position by a controlled pneumatic overpressure in order to stack the layers on the workpiece carrier.

3. The stacking unit according to claim 1, wherein
the first lifting device is provided and is set up to lower the workpiece carrier during stacking of the individual anode layers and individual cathode layers by a distance that corresponds to a thickness of an individual anode layer or an individual cathode layer).

4. The stacking unit according to claim 1, wherein
in the case of two stacking devices assigned to a stacking location, a first of the stacking devices is provided and configured to transport only individual ones of the anode layers to the stacking location, and a second of the stacking devices is provided and configured to transport only individual ones of the cathode layers to the stacking location.

5. The stacking unit according to claim 1, wherein
each of the stacking devices has a support for the individual layers which
has at least one vacuum/overpressure opening or a porous vacuum/over-pressure surface on which the individual layers are held during transport to the stacking position and/or
has recesses which are provided and dimensioned for receiving the at least two clamping fingers before the individual layers are stacked on the workpiece carrier, and for releasing the at least two clamping fingers in the direction of the electrode stack in order to always press the uppermost of the anode and cathode layers against the electrode stack.

6. The stacking unit according to claim 1, wherein
each of the stacking devices is provided and arranged to be brought into the stacking position in a controlled manner at a distance above the electrode stack which corresponds to the thickness of fewer of the individual anode layers or the individual cathode layers in order to release the individual anode layers and the individual cathode layers from there by switching off a pneumatic negative pressure and/or building up a pneumatic positive pressure and/or lowering at least one of the at least two clamping fingers in order to always press the layers against the electrode stack on the work-piece carrier.

7. The stacking unit according to claim 1, wherein
the clamping fingers are assigned to a group of first clamping fingers and a group of second clamping fingers, and are provided and configured to press the respective uppermost of the anode and cathode layers against the electrode stack from one or two sides of the anode and cathode layers in groups; and/or
each of the group of first clamping fingers and the group of second clamping fingers is divided into at least two clamping fingers on two opposite sides of each stacking location, wherein the clamping fingers of a group located on the same side of the stacking location have a common drive.

8. The stacking unit according to claim 1, wherein
each of the stacking devices is provided and is arranged to be brought into the stacking position in a controlled manner at a distance above the electrode stack on the workpiece carrier, the said distance corresponding to the thickness of one or some individual anode layers or cathode layers in order to stack the individual anode and cathode layers on the workpiece carrier from there by lowering at least one of the clamping fingers.

9. The stacking unit according to claim 2, wherein
a receptacle is provided at each stacking location and is arranged to receive at least one empty workpiece carrier and to pick up the empty work-piece carrier in at least one direction with positional accuracy, wherein
each workpiece carrier has an upper side on which one or more clamps are arranged and are adapted to clamp electrode stacks located on the upper side of the workpiece carrier during transport to the next process station, and/or
each clamp has a clamping jaw which is configured to bear on the electrode stack in a first position and to release a storage space for the electrode stack on the workpiece carrier in a second position, and/or
each clamp has a spring device which is configured to urge the clamping jaw into the first position on the electrode stack and has a pressing point which is configured to introduce a force of the actuator into the work-piece carrier, and has a pressing point that is configured to receive a force introduction of the actuator in the stacking unit, the force introduced being directed against the spring device and causing the clamping jaw to release the storage space.

10. A method for the production of modules or precursors of modules comprising:
a pick-up receives at least one empty workpiece carrier from a central transport section at at least one stacking point;
a lifting device removes the at least one empty work piece carrier from the central transport section and, after filling, returns the work-piece carrier to the central transport section for conveying to a subsequent process station; and
one or more stacking devices alternately transport individual anode layers and individual cathode layers to the stacking point to form an electrode stack and stack the anode layers and the cathode layers on the workpiece carrier located at the stacking point;
wherein the method is characterized in that
at least one first and at least one second clamping finger alternately engage with an uppermost of the anode and cathode layers and press and clamp the anode and cathode layers against the electrode stack and onto the workpiece carrier.

11. The stacking unit according to claim 1 wherein the modules or precursors of modules are fuel cells or battery cells including a layer material.

12. The method according to claim 10 wherein the modules or precursors of modules are fuel cells or battery cells including a layer material.
